(19) United States
(12) Patent Application Publication
(10) Pub. No.: US 2014/0101724 A1
(43) Pub. Date: Apr. 10, 2014

(54) NETWORK ATTACK DETECTION AND PREVENTION BASED ON EMULATION OF SERVER RESPONSE AND VIRTUAL SERVER CLONING

(71) Applicant: Galois, Inc., (US)

(72) Inventors: Adam Wick, Portland, OR (US); Trevor Elliott, Portland, OR (US)

(73) Assignee: GALOIS, INC., Portland, OR (US)

(21) Appl. No.: 13/648,868

(22) Filed: Oct. 10, 2012

(51) Int. Cl. G06F 21/30

(52) U.S. Cl. CPC G06F 21/30
USPC 726/4

(57) ABSTRACT

Network attacks can be evaluated to determine typical responses provided by networks configured to provide services. Typically, service requests directed to a selected address are associated with data or a data streams responsive to requests to selected addresses. These responses are used to define scripts that can be executed by decoy nodes responsive to service requests at the selected addresses. Receipt of a request for services at an unused IP address and port number can trigger playback of the associated script, typically as a data stream mimicking that produced by an operational network.

### ACKNOWLEDGMENT OF GOVERNMENT SUPPORT

This invention was made with government support under U.S. Government Prime Contract # HR0011-11-F-0002 awarded by the Defense Advanced Research Projects Agency (DARPA). The government has certain rights in the invention.

### FIELD

The disclosure pertains to computer network security.

### BACKGROUND

Network security has become increasingly important as businesses, individuals, and public agencies have adopted network and Internet-based tools for day to day activities. Some activities involve confidential personal information such as financial or medical records, business sensitive information, or information that is important for national security. Such information offers a tempting target to hackers, and protecting this data from unauthorized access is an important concern.

Some computer attacks related to accessing private information are based on probing network nodes to find vulnerabilities. In some cases, so-call network scanning programs are used that can provide potential attackers with a road map of possible entry points. Moreover, in some cases, the goal of an attacker may be merely to swamp a network using a “denial of service attack” in which repeated requests for service are made. Methods for defense against these and other attacks are needed.

### SUMMARY

Disclosed methods and apparatus analyze communication logs associated with network scanning of one or more target networks, and are configured to create decoy scripts that can be executed in response to requests for services. These scripts are generally configured to simulate responses that would be associated with actual network nodes and available services. For example, a data stream corresponding to a typical response to a particular service request can be used to define an appropriate script. Scripts are typically determined as data sequences such as packet streams that are the same or similar to detected packet streams from a communications log. Decoy nodes that respond with a predetermined data stream tend to place minimal additional burden on existing network resources. In some cases, decoy nodes can be provided with arbitrary delays in script execution so as to provide responses with timing similar to that of actual service nodes.

Execution of scripts can require very few system resources, and a single computing device can typically be provided with hundreds of decoy nodes simultaneously, with each decoy node emulating a full-featured operating system. A decoy node script can merely require look up of a particular value in an internal data table, or can be configured so that the typically few data values needed are defined in the script.

Methods comprise, in a computer network, receiving a service request directed to an unauthorized access point, and providing a decoy response. In some examples, the unauthorized access point is associated with an IP address and a particular TCP port, and the decoy response is based on the particular TCP port. In typical embodiments, the decoy response is provided as a predetermined data stream, and the decoy response is selected based on a data stream associated with the service request. In other examples, the decoy response is selected based on a number of bytes in the data stream associated with the service request. In further embodiments, decoy responses to service requests directed to a plurality of unauthorized access points are provided, wherein the decoy responses are selected based on the associated service requests. In typical embodiments, the decoy responses are selected based on the data streams associated with the service requests. In some examples, the decoy responses are selected based on TCP/IP port numbers associated with the service requests.

Computing devices comprise a processor configured to implement a plurality of decoy nodes based on computer executable instructions stored in a computer storage device, wherein each of the decoy nodes is associated with a response script based on a decoy node address. In some examples, decoy node addresses are IP addresses and port numbers. In some embodiments, at least one of a number of nodes in the plurality of nodes or the addresses associated with the nodes is varied. Typically, the number of nodes is varied based on a number of received unauthorized requests.

Methods comprise establishing a data sequence associated with a response to a request for services. A response script is defined based on the established data sequence. In some examples, data sequences associated with a plurality of requests for services are established, and a corresponding plurality of response scripts is defined. In typical examples, the response scripts are defined based in part on TCP/IP port numbers to which the requests for services are directed. In some embodiments, the response scripts are stored in a computer-readable medium. In other examples, a plurality of network nodes is scanned with requests for services, and network node responses recorded, wherein the response scripts are based on the data sequences in the network node responses. In representative examples, the response scripts are defined as respective series of bytes associated with the network node responses. Computer readable devices are provided that include computer-executable instructions for such methods.

Computing systems comprise at least one computing device configured to execute computer readable instructions to determine a data sequence associated with a request for services directed to a selected network address, and based on the determined data sequence, define a decoy script responsive to corresponding requests for service. In some embodiments, the selected network address comprises an IP address and a port number. In other alternatives, a plurality of decoy scripts is defined for the selected network address. In still further examples, the computer executable instructions are configured to establish a communications log that includes data streams associated with a plurality of requests for services and associated data streams responsive to the requests for services, wherein the determined data sequence is based on at least one of the associated data streams.

Computing devices are configured to execute computer executable instructions to scan at least a plurality of network nodes and record scan responses and associate a plurality of response data streams with scan requests directed to corresponding nodes. Based on the response data streams, decoy responses associated with corresponding nodes are defined. Decoy nodes configured to provide corresponding decoy responses are activated.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram illustrating a method of establishing responses to network scanning.

FIG. 2 is a block diagram illustrating a method of generating decoy node responses.

FIG. 3 is a block diagram illustrating a representative method of sending decoy responses based on a received request for services.

FIG. 4 illustrates a method of establishing decoy nodes.

FIG. 5 illustrates a user interface configured to control decoy node characteristics.

FIG. 6 is a schematic diagram of a network in which a plurality of decoy nodes are deployed.

FIG. 7 illustrates a representative method of establishing and deploying decoy nodes.

FIG. 8 is a block diagram illustrating a method of generating decoy scripts.

FIG. 9A illustrates execution of a representative script.

FIG. 9B illustrates execution of a representative script associated with a plurality of access points.

FIG. 10 illustrates representative scan results.

FIG. 11 illustrates a portion of a representative capture log associated with network scanning.

FIG. 12 illustrates a representative computing environment that can be used to implement the disclosed methods.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

Disclosed herein are methods and apparatus for the creation of false targets on a computer network. Typically, these false targets are configured to respond to inquiries from an attacker so as to appear as normal responses. Thus, an attacker continues to mount an attack against a false target, and the time required for a successful attack against a real network node is increased. Moreover, random attacks on a network can be responded to in ways that use minimal network resources, so that even large numbers of potential unauthorized accesses do not significantly impair network operation.

One goal of providing false targets is to confuse an attacker into attacking the false target instead of a real target on the network. Such false targets can be configured to consume few network resources. In attacking numerous false targets, an attacker must consume increased time to identify and attack a real network node. Delaying an attacker permits providing warnings to a system administrator that an attack is in progress and initiation of defensive measures. Second, for non-directed attacks, the attacker's pay rate is decreased, as fewer computers can be compromised in a given time period. Third, the more attacks an attacker makes, the more evidence is available for identification and prosecution.

Some aspects of methods and systems that can address some or all of these goals are set forth below.

### Example 1

### Scan Response Libraries

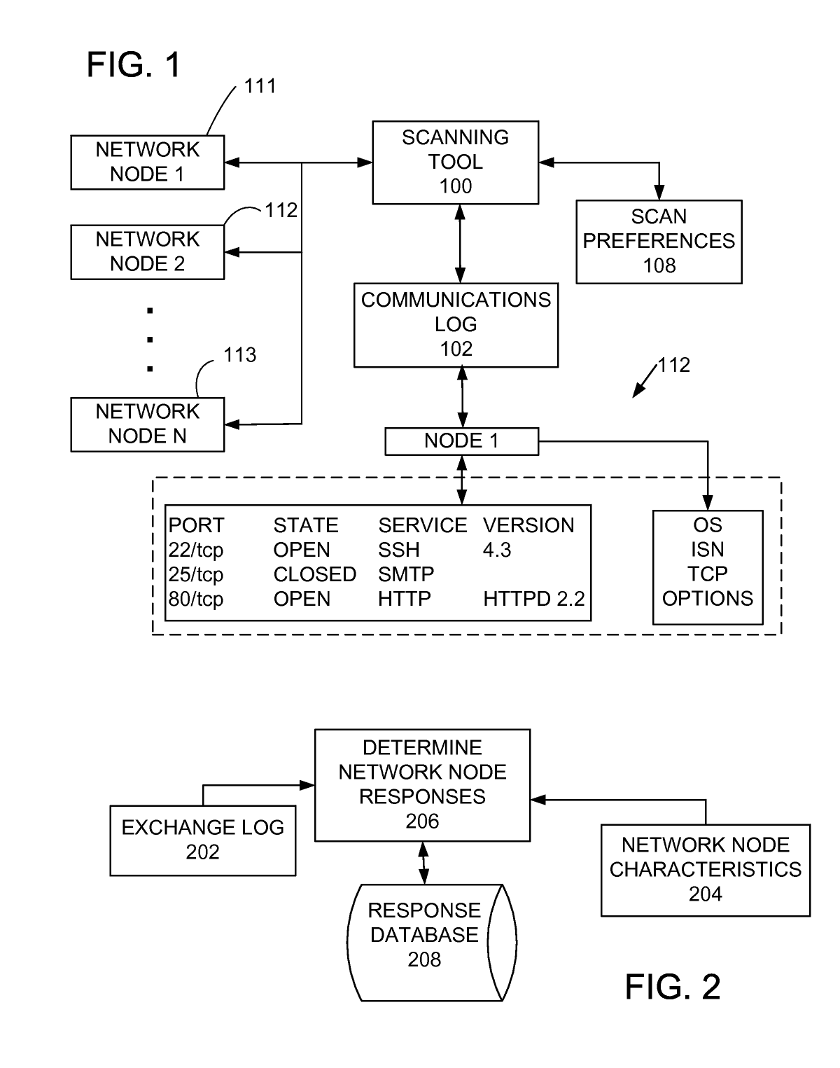

With reference to FIG. 1, a representative method of identifying one or more suitable responses to network scanning and establishing a corresponding library includes scanning a network with a network scanner or “scanning tool” 100 that is configured to scan one or more network nodes 111-113 to identify potential access points. The scanning tool 100 is typically implemented based on a set of computer-executable instructions that can be executed on a computer system such as a desktop computer, server, or other computer system. The scanning tool 100 can be coupled to one or more network nodes such as desktop computers, mobile computing devices, wireless access points, routers, or other devices that can be installed on a network, such as machinery, computer peripherals, or other devices.

As shown in FIG. 1, the scanning tool 100 sends requests for services or information to the network nodes 111-113. For example, the scanning tool can request information concerning the number and type of network nodes and the status of communication ports at some or all nodes. The scanning tool 100 is generally configured to identify and provide information about ports available for use in communication with the network nodes. A network scan is implemented based on one or more sets of scan preferences that can be retrieved from a database stored in a memory 108. For example, only selected ports can be scanned or only selected scan results recorded based stored scan preferences. Communications between the scanned ports of the network nodes 111-113 and the scanning tool 100 are recorded in a communications log 102 so that network node responses to scan inquiries can be stored in a memory 112. As shown in FIG. 1, scan results for node 111 include port numbers, states, services, and version numbers of software configured to provide services.

A typical network scanner such as the scanning tool 100 can be configured to determine available network hosts, services available at the hosts such as particular applications and version numbers of the applications, operating systems and versions thereof associated with the hosts, identifiers of packet filters, firewalls, and other characteristics of hosts. Generally, a network scanner also provides information concerning ports associated with a scanned target. Each port number can be associated with a protocol, service name, state (open, filtered, closed, or unfiltered). An open port state corresponds to a target machine on which an application is listening for connections/packets on the associated port. A port designated as filtered denotes that a filter or firewall or other protective measure is configured to block access to the port, and the scanning tool may be unable to determine if the port is open or closed. A closed port state denotes a port that currently has no application listening. A port that is responsive to a scanner probe can be denoted as unfiltered whether or not the scanner can determined if the port is open or closed. A port table containing port characteristics can also include software version information, if requested. A scan can also be configured to provide information on supported IP protocols, reverse DNS names, operating system guesses, device types, MAC addresses, and a variety of other target characteristics. These and other target characteristics can be stored in the communications log 102 in memory along with the scanner queries that evoked the responses.

In some examples, an operating system (OS) can be identified (or guessed) based on OS fingerprints that can be stored in and retrieved from a database. OS fingerprints can be established by evaluating responses from a target node including response data such as initial sequence numbers (ISNs) or TCP options such as maximum segment size, window scale, selective acknowledgement, or timestamps. Although network nodes may implement random ISNs, a series of ISNs from repeated requests can be used to provide an approximate OS fingerprint. As shown in FIG. 1, such information can also be stored in the memory as part of the communications log 102.

As shown above, a scan log is established by implementing a network scan, and the scan log can include both communications from the scanning tool 100 and responses by the network nodes 111-113. In this example, network scanning is generally intended to be implemented without unauthorized accesses in order to establish request/response patterns can that can be used in defining false targets and configuring suitable false target behaviors as discussed below. In other examples, network scanning is permitted but not initiated, and third party scanning (including unauthorized scanning) can be used to establish a communications log or to supplement an existing communication log.

With reference to FIG. 2, a method of determining suitable responses to unauthorized scanning of an actual network includes obtaining stored node responses at 206 based on a recorded exchange log 202 and network node characteristics 204. For a particular network node, a scan of a selected port can elicit a response based on an associated service, port state, or service version. In the communication log of FIG. 1, scan of port 22 returns “ssh” as an associated service and service version 4.3. Any of a number of other characteristics can be used in a response as appears necessary. Suitable responses can be generated and stored in a script log database 208.

### Example 2

### Responses to Access Requests

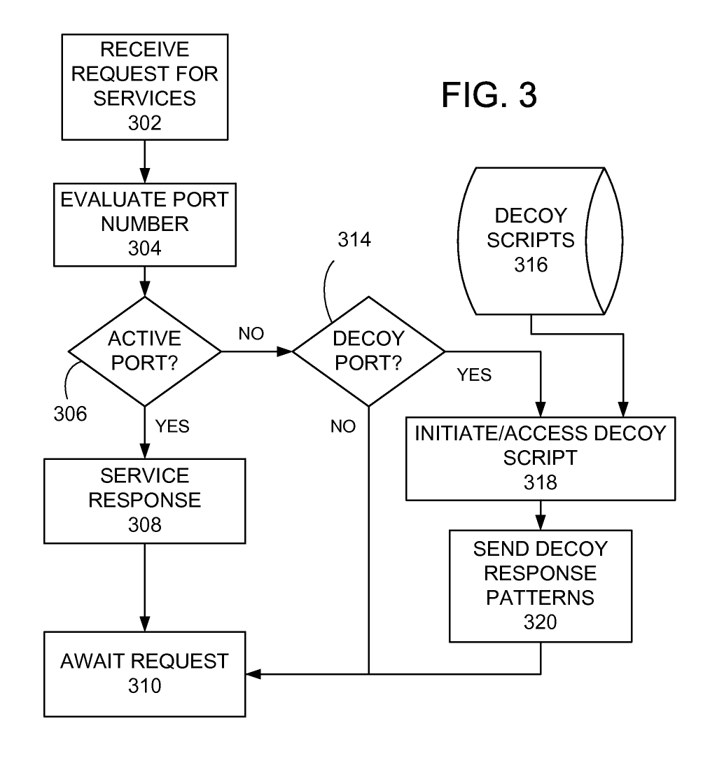

As shown in FIG. 3, a request for services such as an unauthorized port scan is received at 302. The service request is evaluated to determine an associated port number at 304. At 306, the port number is evaluated to determine if the requested port is active, i.e., currently available for authorized access. If the port number is associated with an active port, the service request is forwarded to the port for service. If the port is determined to not be currently in use, the port number is evaluated at 314 to determine if it has been assigned to a decoy node. Typically, only some or a few ports are selected to identify decoy nodes, because a network node that provides responses from an excessive number of ports could be recognized as a decoy, and a scanner would cease scanning this node, and seek other nodes. For an active port, a service request is processed at 308, and additional requests are awaited at 310. For inactive ports that are not associated with decoy scripts, additional requests are awaited at 310 as well.

For ports identified as decoy ports, at 318 a decoy script is initiated or accessed at 318. Decoy scripts can be stored for retrieval in a database 316, typically stored in a non-transitory storage such as ROM, RAM, a disk drive, thumb drive, optical disks, or other tangible storage devices. The selected decoy script produces decoy response patterns at 320. The response patterns simulate active node response patterns, and appear to an unauthorized scanner as representing ports which should be further investigated. Responses can be conveniently based on predetermined data sequences, so that network resources are conserved for authorized users.

### Example 3

### Configuring Decoy Nodes

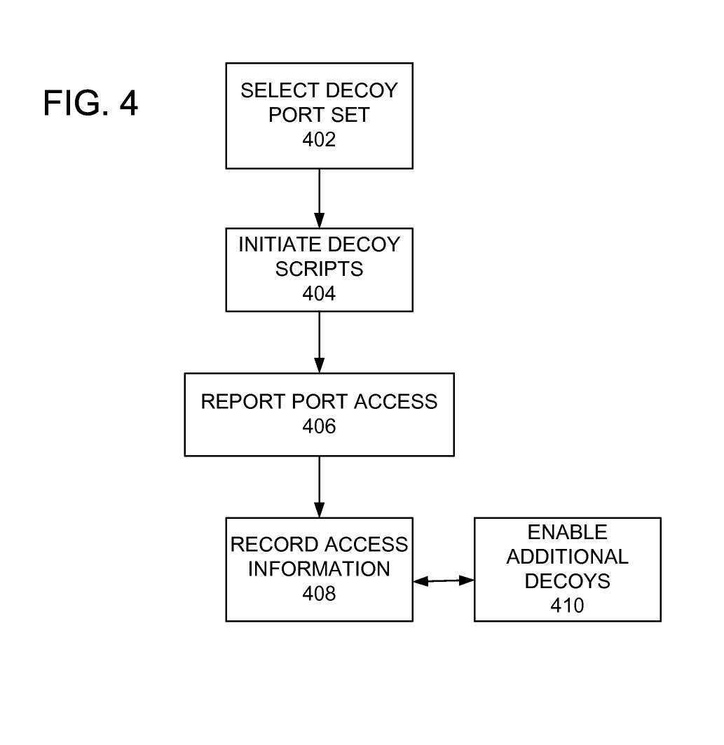

Referring to FIG. 4, at 402 a set of inactive ports is selected to serve as decoy ports. At 404, suitable decoy scripts are assigned to and initiated for the ports of the set of ports. At 406, port access requests with inactive ports are reported or logged, and information associated with the requests for access is logged at 408. Based on a number of access requests for unauthorized ports, additional ports can be enabled at 410 so as to be associated with decoy scripts. Alternatively, one or more decoy ports can be disabled.

### Example 4

### Initiating and Configuring Distributed Decoy Nodes

One or more decoy nodes can be initiated under control of a system administrator, a computing device user, or such nodes can be initiated upon device start up or upon access to network.

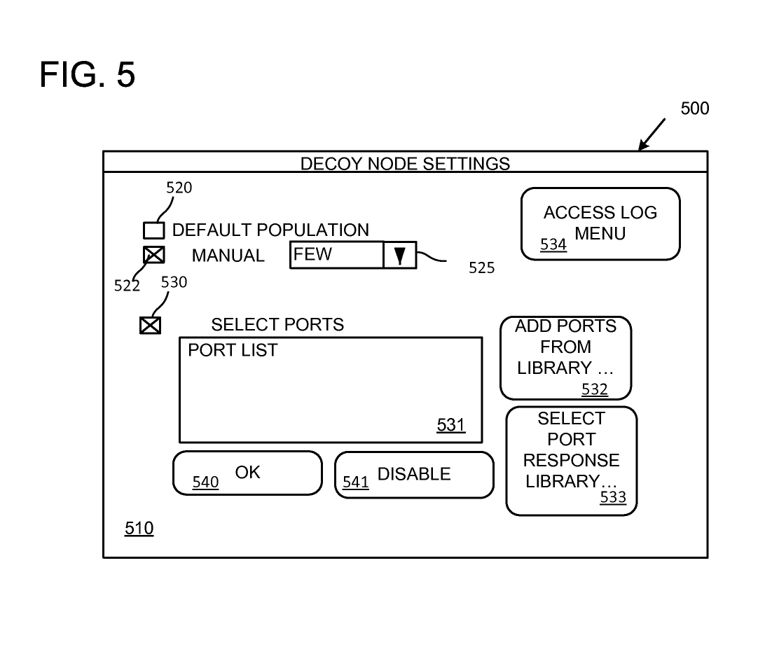

FIG. 5 shows a screen shot 500 of an exemplary user interface 510 for setting decoy node preferences. A number of decoy nodes can be selected using checkboxes 520, 522 that are associated with a default configuration or a manual selection of a relative number with drop down menu 525. Such selections can also be associated with decoy node location in a network, wherein decoy nodes can be assigned to some or all network nodes in different numbers. With checkbox 530, a user can enter particular ports to be associated with decoy nodes at input box 531, or add ports from a library at button 532 and configure decoy node responses at 533 based on manual input or a response library. Logging of accesses can be configured at button 534, and decoy configurations can be accepted at button 540 or disabled at button 541.

### Example 6

### Representative Network

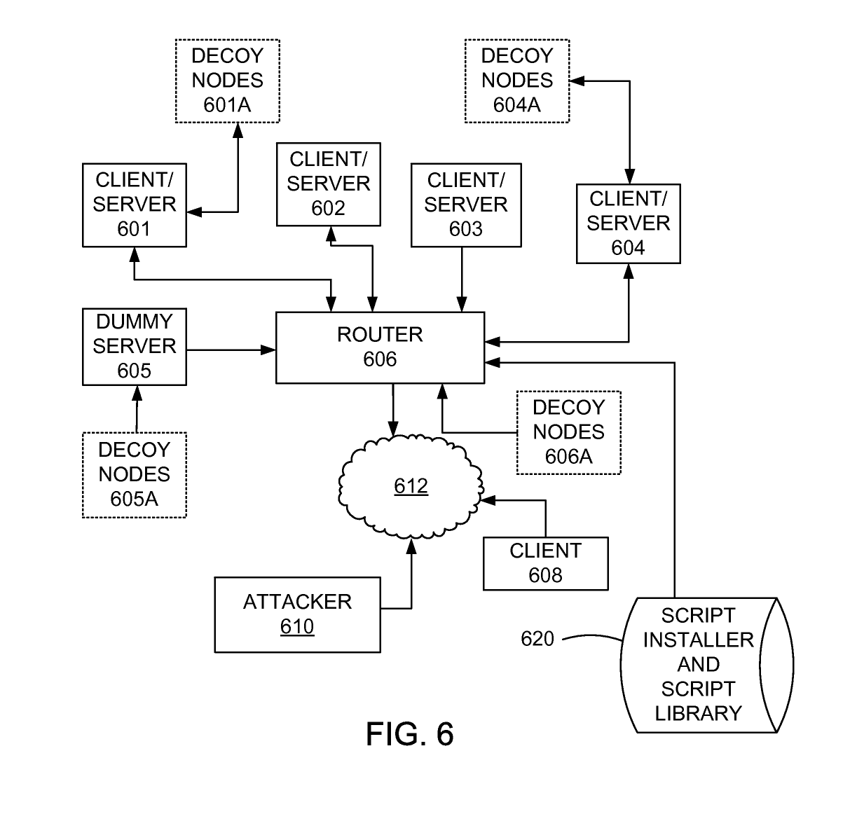

FIG. 6 illustrates a representative network in which decoy ports have been identified and assigned suitable decoy scripts. The network includes clients or servers 601-604 that are coupled to a router 606 via a wide area network 612 such as the internet. Additional clients or servers such as client 608 can communicate with the router 606. A dummy or “decoy” server 605 is also coupled to the router 606 and serves to provide decoy nodes 605A based on decoy node scripts and obtained from a decoy script installer and library 620. In addition, the client/servers 601, 604 are illustrated as implementing decoy nodes 601A, 604A based on the script installer and library 620.

The router 606 is coupled to the wide area network 612, and an attacker 610 can communicate with the router 606. The router 606 can also be configured to provide a decoy node 606A. Based on an attacker's particular request for services, the request can be directed to one or more decoy nodes. As a result, decoy scripts are executed that appear to be the anticipated responses to the request so as to delay or prevent the attacker from becoming aware that the attacking request has been detected and diverted.

### Example 7

### Representative Network with Decoy Nodes

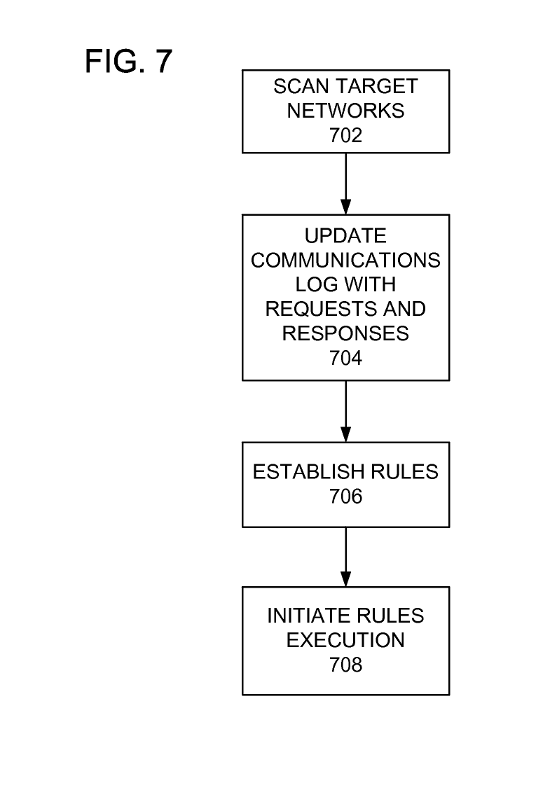

As shown in FIG. 7, selected portions of representative networks are scanned with a scanning tool at 702 to obtain scan requests and responses for storage in a communication log at 704. At 706, rules can be established that correspond to various scan requests and responses for use in establishing decoy nodes. At 706, one or more or of the established rules can be used to establish decoy nodes that can be implemented on one or more dedicated servers or other machines, or in virtual machines using existing network client computers and servers. For example, one or more of the established rules can be initiated at 708.

### Example 8

### Representative Analysis System

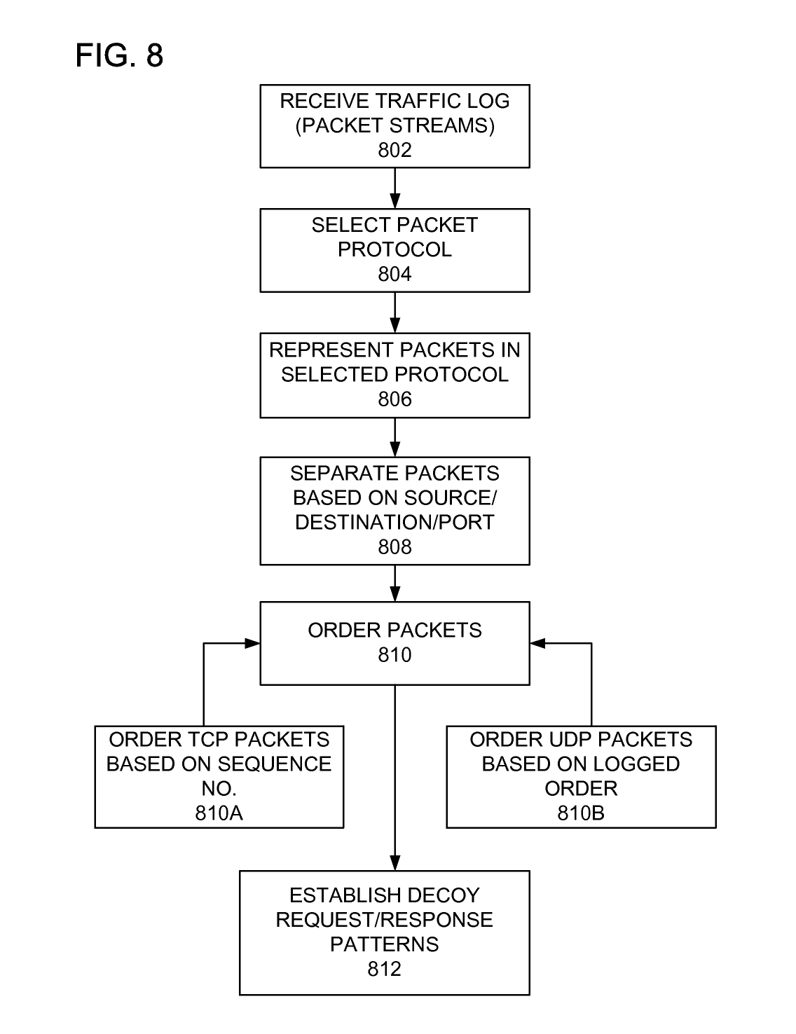

Analysis systems are generally configured to receive a network traffic log associated with communications with one or more computing devices. In one example illustrated in FIG. 8, an analysis tool receives a traffic log as a series of packets or packet streams at 802, and attempts to lift the logged packet streams into their highest-possible semantic forms, induce an order to the packets, and then record this information for a decoy node to replay. The recorded packets, as replayed, are selected so that a decoy node appears to respond exactly as a real network node.

In the first step 804, a protocol, preferably a highest-possible protocol that a given packet represents is identified up to a transport layer of a network stack. For example, protocol characteristics 810A, 810B for TCP packets and UDP packets, respectively can be used. For example, every packet sent as part of an HTTP request can be viewed as an Ethernet packet, a TCP packet, and an HTTP packet. Typically, Ethernet packet and HTTP packet based analyses are not as useful as TCP packet analyses as Ethernet and HTTP are relatively too low-level and too high-level, respectively. At 806, packets are represented based on the selected packet protocol. Thus, for example, packets that are part of an HTTP transmission are represented as TCP packets. At 808, packets are separated based on which computing device is sending packets, which computing device is the intended recipient and at which port the request is directed. For example, a list of packets is created for communications between a machine at IP address 192.168.80.5 (port 35078) and a machine at IP address 192.168.80.15 (port 80). This separates packets into groupings that represent “conversations” between the two machines.

Typically, network communications does not guarantee in-order packet delivery to a logging host, and an intended order is estimated at 810 for one or more of the packet groupings. For UDP packets, it is typically impossible to fully recreate the order between packets. Packet ID numbers can be used to order each side of a packet grouping (i.e., communications from each machine can be arranged in order), but correct interleaving cannot be guaranteed. Typically, the order in which packets are recorded is adequate, and this tends to be more accurate in ordering packets logged from a small, tightly-bound, local network. TCP packets can be ordered based on TCP sequence numbers and acknowledgement numbers to recreate packet stream order. Packets associated with incomplete TCP handshakes are generally discarded and not used for analysis. The ordered packets can be used to establish request/response structures for decoy nodes at 812.

### Example 9

### Representative Scripts and Script Processing

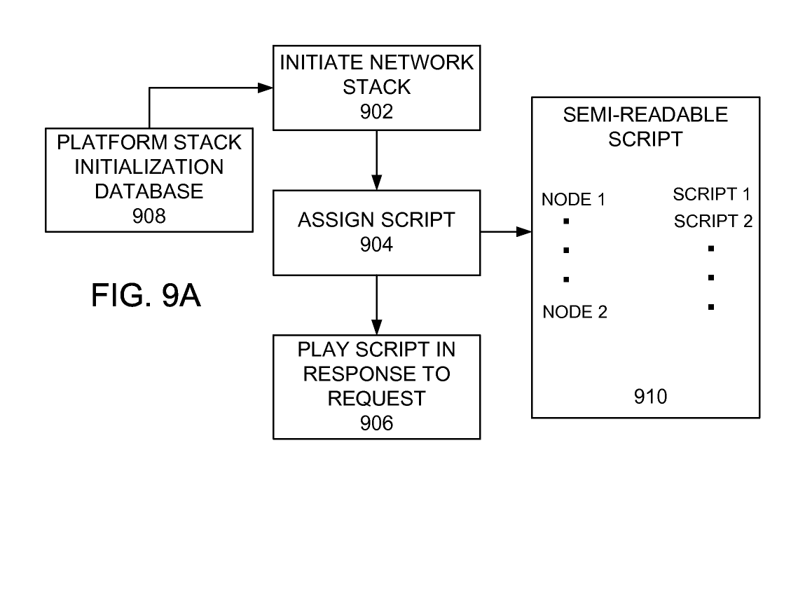

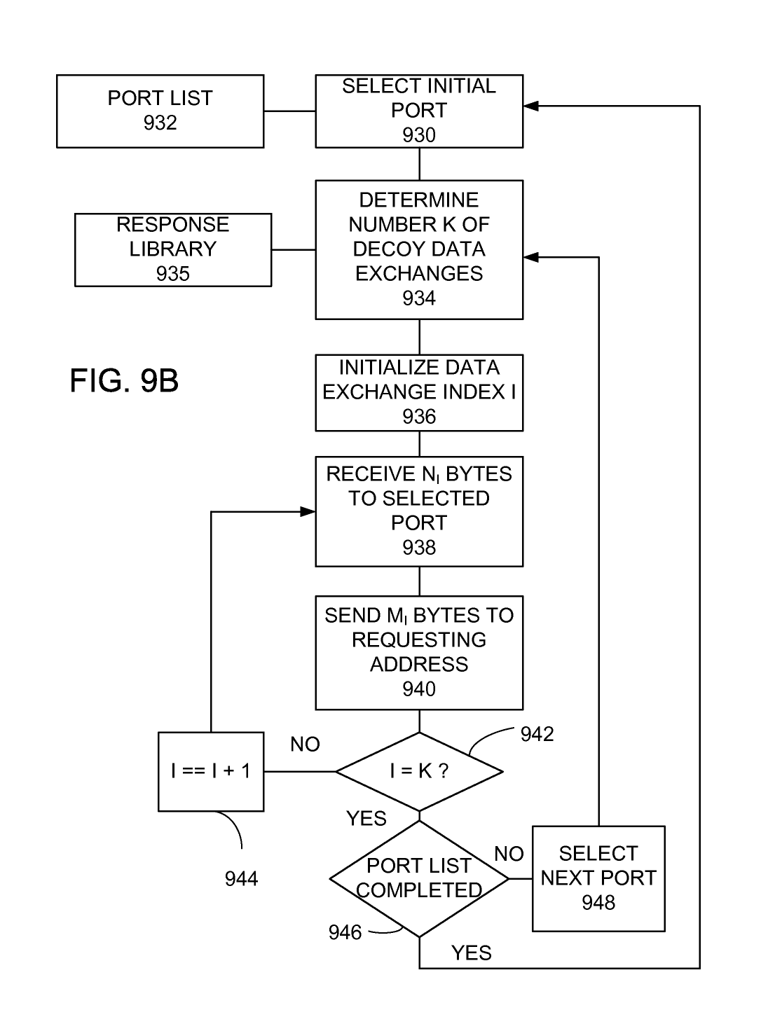

Decoy nodes are generally configured to play predefined scripts selected to mimic the behavior of actual resources. For example, as shown in FIG. 9A, a decoy node is prepared to play a script by initializing its network stack at 902. An appropriate script is provided at 904, and the script is executed at 906, typically by providing a data stream defined by the script. Network stack initialization and script provisioning are generally platform-specific, and can be based on platform-specific parameters stored in a database at 908. Scripts can be provided as command line arguments or as virtual disks to be read by a decoy node. Scripts can be stored in a semi-readable text format at 910, corresponding to a compiler's default print and read routines for the associated data structures.

Typical scripts comprise a series of entries, one per TCP and UDP port, and each entry is a list of commands, wherein commands can be one of GET, SEND, or CLOSE. GET commands request that the node wait for a specified number of bytes to appear on the given port. SEND commands request that the node send some piece of data, while CLOSE commands request that the node CLOSE the connection. In addition, for any given TCP port, the node may have multiple entries. For example, for port X, the script may have one entry associated with a GET of 20 bytes, a SEND of 40 bytes, followed by a CLOSE command. The node may also have another entry associated with a GET of 30 bytes, a SEND of 20 bytes, followed by a CLOSE command.

If a node has more than one script available, a particular script can be selected as follows. First, if a SEND is the first command of any entry, the associated data can be sent, the SEND command removed from the entry, followed by the next steps in the script. Otherwise, a largest GET request for each of the available entries is found, and a read is issued on the port. The READ returns some number of bytes, for example x bytes, find a GET command for x bytes, if there is one, and remove it, and move them to the next step. If there is no exact match for x, then remove any entries whose first command is a GET of less than x bytes. From the remaining, replace all GET commands of length y with GET commands of y-x bytes. Otherwise, CLOSE all entries.

A representative script configured to provide decoy responses associated with service requests to a plurality of access points such as TCP ports is illustrated in FIG. 9B. At 930, a port is selected from a list of ports and at 934, a number of decoy data exchanges is determined based on, for example, a response library 935. At 936, a data exchange index I is initiated, and at 938, receipt of N_{I}/bytes from a service requestor is awaited. At 940, M_{I} bytes are sent to a requesting address. At 942, it is determined if all K data exchanges associated decoy responses to the selected port have been completed. If not, at 944 the exchange index I is incremented, and processing returns to 938. Otherwise, the port list is checked at 946 to determine if additional ports are to be selected for decoy responses. A next port can be selected at 948, and processing returns to determination of numbers of decoy data exchanges at 934. Otherwise, scanning of all selected ports can be re-initiated at 930.

A specification of a representative script is illustrated below. This script (denoted by the Script keyword) denotes a series of TCP scripts (denoted by TcpScripts) and UDP scripts (denoted by UdpScripts). Each TCP script specifies a port number (TcpPort{getPort=X}) and a script to run for that port. For example, for port 139, the script is to wait to receive 18 bytes, send a response, and then close the port. Note that for port 445, there are three possible interchanges allowed: one beginning with getting 53 bytes from the network, one beginning with getting 75 bytes from the network, and one beginning with getting 168 bytes from the network. The UDP scripts are simpler, and are simply comprised of pairs (denoted “(x, y)”) of requests and responses associated with a given port (denoted with UdpPort).

Script {

scriptTcp = TcpScripts {

tcpDefaultScript = Nothing,
tcpPorts = fromList [

(TcpPort {getPort = 139},

[TcpScript {tcpMessages = [Get 18,

Send <bytes>,
Close]}]),

(TcpPort {getPort = 445},

[TcpScript {tcpMessages = [Get 53,

Send <bytes>,
Get 139,
Send <bytes>,
Get 87,
Send <bytes>,
Get 43,
Send <bytes>,
Close]},

TcpScript {tcpMessages = [Get 75,

Send <bytes>,
Close]},

TcpScript {tcpMessages = [Get 168,

Send <bytes>,
Close]}])]},

scriptUdp = UdpScripts {

udpDefaultScript = Nothing,
udpPorts = fromList [

(UdpPort {getUdpPort = 137},

UdpScript {udpMessages = fromList

[(<bytes>,<bytes>)]}),
(UdpPort {getUdpPort = 32527},

UdpScript {udpMessages = fromList [ ]}),

(UdpPort {getUdpPort = 49695},

UdpScript {udpMessages = fromList [ ]}),

(UdpPort {getUdpPort = 51239},

UdpScript {udpMessages = fromList [ ]})]}}

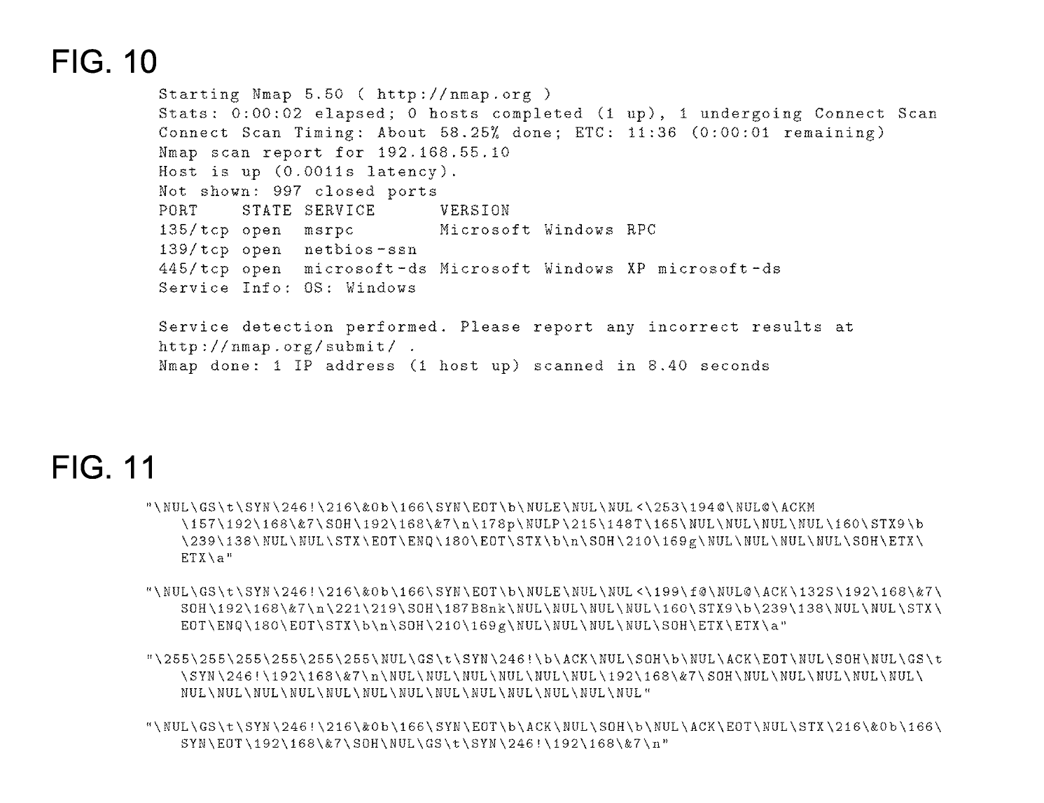

As discussed above, scripts are determined based on network scan results such as those illustrated in FIGS. 10-11. FIG. 10 illustrates can results based on a widely available network scanner (nmap), and FIG. 11 is a portion of a communications log associated with scanning

### Example 10

### Representative Computing Environment

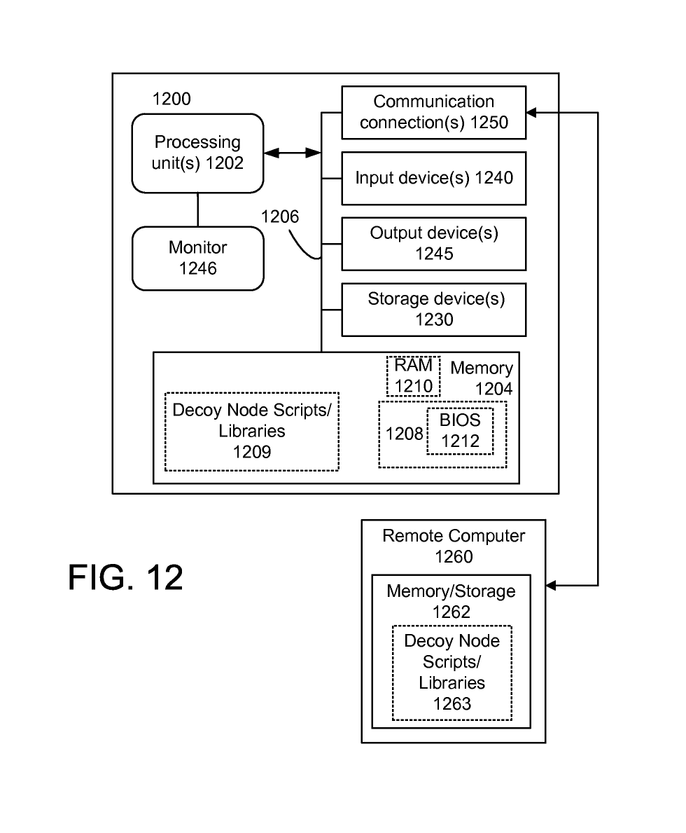

FIG. 12 and the following discussion are intended to provide a brief, general description of an exemplary computing environment in which the disclosed technology may be implemented. Although not required, the disclosed technology is described in the general context of computer-executable instructions, such as program modules, being executed by a personal computer (PC). Generally, program modules include routines, programs, objects, components, data structures, etc., that perform particular tasks or implement particular abstract data types. Moreover, the disclosed technology may be implemented with other computer system configurations, including hand-held devices, multiprocessor systems, microprocessor-based or programmable consumer electronics, network PCs, minicomputers, mainframe computers, and the like. The disclosed technology may also be practiced in distributed computing environments where tasks are performed by remote processing devices that are linked through a communications network. In a distributed computing environment, program modules may be located in both local and remote memory storage devices.

With reference to FIG. 12, an exemplary system for implementing the disclosed technology includes a general purpose computing device in the form of an exemplary conventional PC 1200, including one or more processing units 1202, a system memory 1204, and a system bus 1206 that couples various system components including the system memory 1204 to the one or more processing units 1202. The system bus 1206 may be any of several types of bus structures including a memory bus or memory controller, a peripheral bus, and a local bus using any of a variety of bus architectures. The exemplary system memory 1204 includes read only memory (ROM) 1208 and random access memory (RAM) 1210. A basic input/output system (BIOS) 1212, containing the basic routines that help with the transfer of information between elements within the PC 1200, is stored in ROM 1208. Memory portion 1209 is provided with decoy node instructions, scripts, and libraries configured to install, configure, and execute one or more decoy nodes.

The exemplary PC 1200 further includes one or more storage devices 1230 such as a hard disk drive for reading from and writing to a hard disk, a magnetic disk drive for reading from or writing to a removable magnetic disk, and an optical disk drive for reading from or writing to a removable optical disk (such as a CD-ROM or other optical media). Such storage devices can be connected to the system bus 1206 by a hard disk drive interface, a magnetic disk drive interface, and an optical drive interface, respectively. The drives and their associated computer-readable media provide nonvolatile storage of computer-readable instructions, data structures, program modules, and other data for the PC 1200. Other types of computer-readable media which can store data that is accessible by a PC, such as magnetic cassettes, flash memory cards, digital video disks, CDs, DVDs, RAMs, ROMs, and the like, may also be used in the exemplary operating environment.

A number of program modules may be stored in the storage devices 1230 including an operating system, one or more application programs, other program modules, and program data. A user may enter commands and information into the PC 1200 through one or more input devices 1240 such as a keyboard and a pointing device such as a mouse. Other input devices may include a digital camera, microphone, joystick, game pad, satellite dish, scanner, or the like. These and other input devices are often connected to the one or more processing units 1202 through a serial port interface that is coupled to the system bus 1206, but may be connected by other interfaces such as a parallel port, game port, or universal serial bus (USB). A monitor 1246 or other type of display device is also connected to the system bus 1206 via an interface, such as a video adapter. Other peripheral output devices, such as speakers and printers (not shown), may be included.

The PC 1200 may operate in a networked environment using logical connections to one or more remote computers, such as a remote computer 1260. In some examples, one or more network or communication connections 1250 are included. The remote computer 1260 may be another PC, a server, a router, a network PC, or a peer device or other common network node, and typically includes many or all of the elements described above relative to the PC 1200, although only a memory storage device 1262 has been illustrated in FIG. 12. The personal computer 1200 and/or the remote computer 1260 can be connected to a logical a local area network (LAN) and a wide area network (WAN). Such networking environments are commonplace in offices, enterprise-wide computer networks, intranets, and the Internet. As shown in FIG. 12, the remote computer 1260 includes memory 1263 in which decoy node instructions can be stored. For example, the memory 1262 can include scripts (and data) used to respond to an authorized request for services. In addition, the memory 1263 can include computer-executable instructions and libraries for installation, configuration, and customization of decoy nodes.

When used in a LAN networking environment, the PC 1200 is connected to the LAN through a network interface. When used in a WAN networking environment, the PC 1200 typically includes a modem or other means for establishing communications over the WAN, such as the Internet. In a networked environment, program modules depicted relative to the personal computer 1200, or portions thereof, may be stored in the remote memory storage device or other locations on the LAN or WAN. The network connections shown are exemplary, and other means of establishing a communications link between the computers may be used.

Having described and illustrated the principles of the disclosed technology with reference to the illustrated embodiments, it will be recognized that the illustrated embodiments can be modified in arrangement and detail without departing from such principles. For instance, elements of the illustrated embodiments shown in software may be implemented in hardware and vice-versa. Also, the technologies from any example can be combined with the technologies described in any one or more of the other examples. It will be appreciated that procedures and functions such as those described with reference to the illustrated examples can be implement in a single hardware or software module, or separate modules can be provided. The particular arrangements above are provided for convenient illustration, and other arrangements can be used.

We claim:

1. A method, comprising:
in a computer network, receiving a service request directed to an unauthorized access point; and
providing a decoy response.

2. The method of claim 1, wherein the unauthorized access point is associated with an IP address and a particular TCP port, and the decoy response is based on the particular TCP port.

3. The method of claim 1, wherein the decoy response is provided as a predetermined data stream.

4. The method of claim 3, wherein the decoy response is selected based on a data stream associated with the service request.

5. The method of claim 4, wherein the decoy response is selected based on a number of bytes in the data stream associated with the service request.

6. The method of claim 1, further comprising providing decoy responses to service requests directed to a plurality of unauthorized access points, wherein the decoy responses are selected based on the associated service requests.

7. The method of claim 6, wherein the decoy responses are selected based on the data streams associated with the service requests.

8. The method of claim 7, wherein the decoy responses are selected based on TCP/IP port numbers associated with the service requests.

9. A computing device, comprising a processor configured to implement a plurality of decoy nodes based on computer executable instructions stored in a computer storage device, wherein each of the decoy nodes is associated with a response script based on a decoy node address.

10. The computing device of claim 9, wherein the decoy node addresses are IP addresses and port numbers.

11. The computing device of claim 10, wherein at least one of a number of nodes in the plurality of nodes or the addresses associated with the nodes is varied.

12. The computing device of claim 10, wherein the number of nodes is varied based on a number of received unauthorized requests.

13. A method, comprising:
establishing a data sequence associated with a response to a request for services; and
defining a response script based on the established data sequence.

14. The method of claim 13, further comprising establishing data sequences associated with a plurality of requests for services, and defining a corresponding plurality of response scripts.

15. The method of claim 14, wherein the response scripts are defined based in part on TCP/IP port numbers to which the requests for services are directed.

16. The method of claim 15, further comprising stored the response scripts in a computer-readable medium.

17. The method of claim 13, further comprising scanning a plurality of network nodes with requests for services, and recording network node responses, wherein the response scripts are based on the data sequences in the network node responses.

18. The method of claim 17, wherein the response scripts are defined as respective series of bytes associated with the network node responses.

19. At least one computer readable device, comprising computer-executable instructions for the method of claim 13.

20. A computing system, comprising at least one computing device configured to execute computer readable instructions to:
determine a data sequence associated with a request for services directed to a selected network address; and
based on the determined data sequence, define a decoy script responsive to corresponding requests for service.

21. The computing system of claim 20, wherein the selected network address comprises an IP address and a port number.

22. The computing system of claim 21, wherein the computer-executable instructions further comprise defining a plurality of decoy scripts for the selected network address.

23. The computing system of claim 20, further comprising computer executable instructions to establish a communications log that includes data streams associated with a plurality of requests for services and associated data streams responsive to the requests for services, wherein the determined data sequence is based on at least one of the associated data streams.

24. A computing device, configured to execute computer executable instructions to:
scan at least a plurality of network nodes and record scan responses;
associate a plurality of response data streams with scan requests directed to corresponding nodes;
based on the response data streams, define decoy responses associated with corresponding nodes; and
activate decoy nodes configured to provide corresponding decoy responses.

25. The computing device of claim 24, wherein at least one of the decoy responses includes an operating system specific response portion.
